(19) United States
(12) Patent Application Publication
(10) Pub. No.: US 2009/0061056 A1
(43) Pub. Date: Mar. 5, 2009

(54) METHOD OF PREPARING PICKLES

(75) Inventor: Tammi J. Heuck, Everly, IA (US)

Correspondence Address: ZARLEY LAW FIRM P.L.C., CAPITAL SQUARE, 400 LOCUST, SUITE 200, DES MOINES, IA, 50309-2350, US

(73) Assignee: TAMS, L.L.C., Everly, IA (US)

(21) Appl. No.: 12/167,490

(22) Filed: Jul. 3, 2008

Related U.S. Application Data
(60) Provisional application No. 60/968,923, filed on Aug. 30, 2007.

(51) Int. Cl. A23L 1/218; A23L 1/22; A23L 1/275; A23L 1/27

(52) U.S. Cl. 426/233

(57) ABSTRACT

A method of forming glazed, bluish-green pickles. Sugar, water and cider vinegar are mixed together and boiled to form a mixture. At this point of time green food coloring is added to the mixture and stirred in vigorously. After the green food coloring is added to the mixture pickles are added to the mixture wherein the pickles absorb the mixture. By absorbing the mixture the pickles have a bluish-green glaze to make them aesthetically pleasing and additionally sweeter, thus making the pickles better tasting.

### CROSS REFERENCE TO RELATED APPLICATION

This application claims the benefit of U.S. Provisional Application No. 60/968,923 filed Aug. 30, 2007.

### BACKGROUND OF THE INVENTION

This invention is directed toward a method of preparing a food product. More specifically, the invention is directed toward a method of preparing pickles.

Pickles have been prepared and sold in stores form many years. Traditionally pickles are placed in a brine solution within a jar and sold in stores in mass quantities. Pickles, like most vegetables, do not stand out on their own and have a dull green color that is not esthetically pleasing to the common purchaser. Additionally, dill pickles are often considered sour by individuals eating them and leave an undesirable taste in the mouth of the consumer. Therefore, there is a need in the art for preparing pickles that will not only be esthetically pleasing but additionally enhance the taste of the pickle.

### BRIEF SUMMARY OF THE INVENTION

A method of preparing pickles. The steps include draining brine from a predetermined amount of pickles and slicing the pickles into a plurality of pieces. Next, a mixture is formed by mixing and boiling together sugar, water and cider vinegar at a predetermined temperature for a predetermined amount of time. Green food coloring is then added to the mixture while stirring the mixture. After the green food coloring has been added to the mixture the pickles are added to the mixture and allowed to cook. As the pickles cook in the mixture the pickles absorb a portion of the mixture such that after the pickles absorb a portion of the mixture the pickles have a glazed appearance.

### DESCRIPTION OF THE PREFERRED EMBODIMENT

Provided is a method of preparing pickles. The first step of the method is to gather the needed ingredients in order to prepare the pickles. In a preferred embodiment the list of ingredients are as follows:

1 quart baby kosher dill pickles

2 cups sugar

1 cup water

½ cup cider vinegar

1 teaspoon green food coloring

The above referenced amounts of ingredients are a preferred embodiment. The amounts of each ingredient can vary without falling outside the scope of the invention. Specifically, as long as the ingredients are in proper proportion to one another, any amount of ingredient can be presented. For example only, 4 quarts or a gallon of baby kosher dill pickles could be provided wherein 8 cups of sugar are provided, 4 cups of water, 2 cups cider vinegar and 4 teaspoons of green food coloring. In other words, mass production of the product could be provided as long as the ratios remain the same such as two parts sugar for every one part of water and half a part of cider vinegar, etc.

Once the ingredients are gathered the baby kosher dill pickles are drained out of their brine solution and sliced into a plurality of pieces. In a preferred embodiment the baby kosher dill pickles are sliced into half inch pieces. Additionally, during this step the brine solution can be discarded.

The next step is to mix and boil together the sugar, water, and cider vinegar at a predetermined temperature for a predetermined amount to form a mixture. Preferably the mixture is boiled until the mixture has a light syrup consistency. In a preferred embodiment the mixture is boiled together at a temperature at 325 degrees for approximately 5 minutes while often being stirred.

After the mixture is at a light syrup consistency, the green food coloring is added while stirring the mixture. Once the green food coloring is mixed within the mixture, the pickles are added. At this time the pickles absorb the mixture therein as the mixture is cooked into the pickles.

The end result is a pickle having a neon-like or glazed appearance. Specifically, the pickles are of bluish green consistency providing an esthetically pleasing look to the pickle. Similarly, because of the absorption of the sugar and vinegar therein the taste of the pickle additionally is altered and is sweetened to provide a more pleasing taste to a consumer for consumption. At this time the pickles are placed into a jar and are ready to be provided for consumption.

By using this method for preparing pickles the pickles not only end up with a glazed or esthetically pleasing appearance that is unusual and attracts consumers but a new taste is provided. Thus, consumers of pickles are more likely to be attracted to the pickle for initial tasting wherein the tasting keeps the consumer coming back for additional samplings. Thus at the very least, the stated problems associated with the pickles have been overcome.

It will be appreciated by those skilled in the art that other various modifications could be made to the method without departing from the spirit and scope of this invention. All such modifications and changes fall within the scope of the claims and are intended to be covered thereby.

What is claimed is:

1. A method of preparing pickles steps comprising the steps of:
draining brine from a predetermined amount of pickles and slicing the pickles into a plurality of pieces;
mixing and boiling sugar, water and cider vinegar at a predetermined temperature for a predetermined amount of time to form a mixture;
adding green food coloring to the mixture;
adding the pickles to the mixture after the green food coloring has been added;
cooking the mixture into the pickles wherein the pickles absorb a portion of the mixture; and
wherein after the pickles absorb the portion of the mixture the pickles have a glazed appearance.

2. The method of claim 1 wherein the pickles are baby kosher dill pickles.

3. The method of claim 1 wherein for every one part of cider vinegar, two parts of water and four parts of sugar are mixed and boiled to form the mixture.

4. The method of claim 3 wherein for every part of cider vinegar in the mixture eight parts of pickles are added.

5. The method of claim 4 wherein a half cup of cider vinegar is in the mixture.

6. The method of claim 5 wherein one teaspoon of green food coloring is added to the mixture.

7. The method of claim 1 wherein the predetermined temperature is 325 degrees Fahrenheit.

8. The method of claim 7 wherein the predetermined amount of time is five minutes.

9. The method of claim 1 wherein the pickles are bluish green after the pickles absorb the portion of the mixture.
